(19) United States
(12) Patent Application Publication
(10) Pub. No.: US 2009/0313286 A1
(43) Pub. Date: Dec. 17, 2009

(54) GENERATING TRAINING DATA FROM CLICK LOGS

(75) Inventors: Nina Mishra, Newark, CA (US); Rakesh Agrawal, San Jose, CA (US); Sreenivas Gollapudi, Cupertino, CA (US); Alan Halverson, Sunnyvale, CA (US); Krishnaram N. G. Kenthapadi, Mountain View, CA (US); Rina Panigrahy, Mountain View, CA (US); John C. Shafer, Los Altos, CA (US); Panayiotis Tsaparas, Palo Alto, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/140,272

(22) Filed: Jun. 17, 2008

(51) Int. Cl. G06F 7/00; G06F 17/30

(52) U.S. Cl. 707/102; 707/E17.005

(57) ABSTRACT

Data from a click log may be used to generate training data for a search engine. The pages clicked as well as the pages skipped by a user may be used to assess the relevance of a page to a query. Labels for training data may be generated based on data from the click log. The labels may pertain to the relevance of a page to a query.

### BACKGROUND

It has become common for users of host computers connected to the World Wide Web (the “web”) to employ web browsers and search engines to locate web pages having specific content of interest to users. A search engine, such as Microsoft's Live Search, indexes tens of billions of web pages maintained by computers all over the world. Users of the host computers compose queries, and the search engine identifies pages that match the queries, e.g., pages that include key words of the queries. These pages are known as a result set. In many cases, ranking the pages in the result set is computationally expensive at query time.

A number of search engines rely on many features in their ranking techniques. Sources of evidence can include textual similarity between query and pages or query and anchor texts of hyperlinks pointing to pages, the popularity of pages with users measured for instance via browser toolbars or by clicks on links in search result pages, and hyper-linkage between web pages, which is viewed as a form of peer endorsement among content providers. The effectiveness of the ranking technique can affect the relative quality or relevance of pages with respect to the query, and the probability of a page being viewed.

Some existing search engines rank search results via a function that scores pages. The function is automatically learned from training data. Training data is in turn created by providing query/page combinations to human judges who are asked to label a page based on how well it matches a query, e.g., perfect, excellent, good, fair, or bad. Each query/page combination is converted into a feature vector that is then provided to a machine learning algorithm capable of inducing a function that generalizes the training data.

For common-sense queries, it is likely that a human judge can come to a reasonable assessment of how well a page matches a query. However, there is a wide variance in how judges evaluate a query/page combination. This is in part due to prior knowledge of better or worse pages for queries, as well as the subjective nature of defining “perfect” answers to a query (this also holds true for other definitions such as “excellent,” “good,” “fair,” and “bad”, for example). In practice, a query/page pair is typically evaluated by just one judge. Furthermore, judges may not have any knowledge of a query and consequently provide an incorrect rating. Finally, the large number of queries and pages on the web implies that a very large number of pairs will need to be judged. It will be challenging to scale this human judgment process to more and more query/page combinations.

### SUMMARY

Data from a click log may be used to generate training data for a search engine. The pages clicked as well as the pages skipped by a user may be used to assess the relevance of a page to a query. Labels for training data may be generated based on data from the click log. The labels may pertain to the relevance of a page to a query.

In an implementation, the relevance of a page relative to another page in the result set for a query may be determined based on counts of clicks and skips for pairs of pages in the result set.

In another implementation, a page may be ranked or labeled with respect to the strength of its match or relevance for a query. The ranking may be numerical (e.g., on a numerical scale such as 1 to 5, 0 to 10, etc.) or textual (e.g., “perfect”, “excellent”, “good”, “fair”, “bad”, etc.).

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 illustrates an exemplary environment that may be used to generate training data from click logs;

FIG. 2 is an operational flow of an implementation of a method of generating training data from click logs;

FIG. 3 is an operational flow of another implementation of a method of generating training data from click logs;

FIG. 4 is an operational flow of another implementation of a method of generating training data from click logs;

FIG. 5 is a diagram of an example graph that may be useful in describing aspects of the implementations;

FIG. 6 is an operational flow of another implementation of a method of generating training data from click logs;

FIG. 7 is an operational flow of another implementation of a method of generating training data from click logs;

FIG. 8 is a diagram of another example graph that may be useful in describing aspects of the implementations; and

FIG. 9 shows an exemplary computing environment.

### DETAILED DESCRIPTION

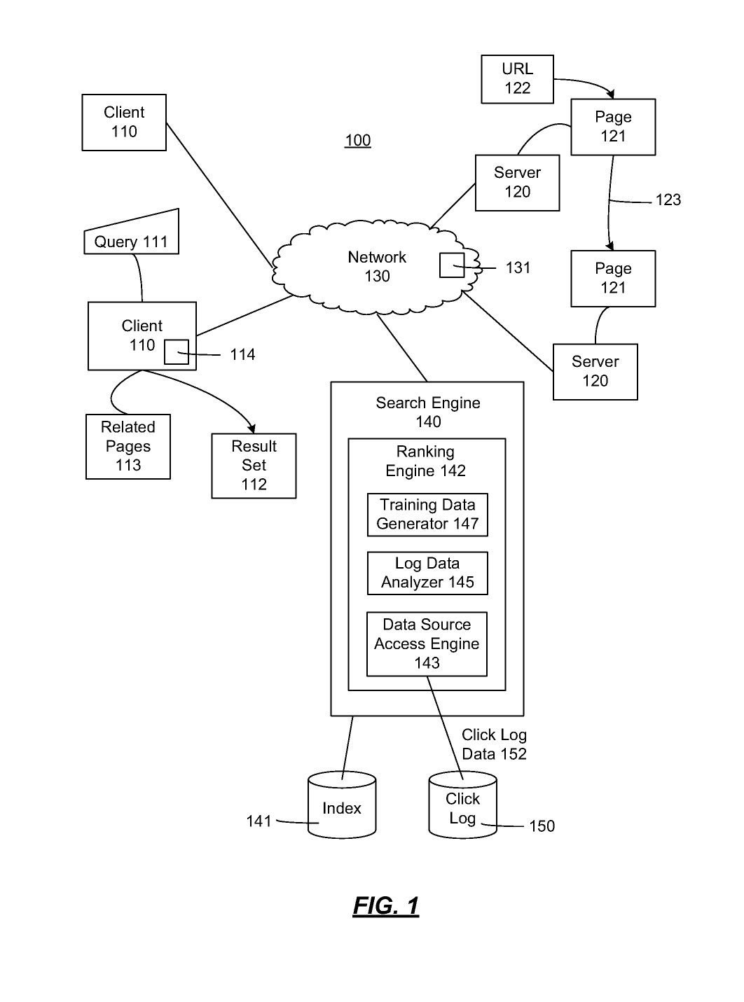

FIG. 1 illustrates an exemplary environment 100. The environment includes one or more client computers 110 and one or more server computers 120 (generally “hosts”) connected to each other by a network 130, for example, the Internet, a wide area network (WAN) or local area network (LAN). The network 130 provides access to services such as the World Wide Web (the “web”) 131.

The web 131 allows the client computer(s) 110 to access documents containing text-based or multimedia content contained in, e.g., pages 121 (e.g., web pages or other documents) maintained and served by the server computer(s) 120. Typically, this is done with a web browser application program 114 executing in the client computer(s) 110. The location of each page 121 may be indicated by an associated uniform resource locator (URL) 122 that is entered into the web browser application program 114 to access the page 121. Many of the pages may include hyperlinks 123 to other pages 121. The hyperlinks may also be in the form of URLs. Although implementations are described herein with respect to documents that are pages, it should be understood that the environment can include any linked data objects having content and connectivity that may be characterized.

In order to help users locate content of interest, a search engine 140 may maintain an index 141 of pages in a memory, for example, disk storage, random access memory (RAM), or a database. In response to a query 111, the search engine 140 returns a result set 112 that satisfies the terms (e.g., the keywords) of the query 111.

Because the search engine 140 stores many millions of pages, the result set 112, particularly when the query 111 is loosely specified, can include a large number of qualifying pages. These pages may or may not be related to the user's actual information needs. Therefore, the order in which the result set 112 is presented to the client 110 affects the user's experience with the search engine 140.

In an implementation, a ranking process may be implemented as part of a ranking engine 142 within the search engine 140. The ranking process may be based upon a click log 150, described further herein, to improve the ranking of pages in the result set 112 so that pages 113 related to a particular topic may be more accurately identified.

For each query 111 that is posed to the search engine 140, the click log 150 may comprise the query 111 posed, the time at which it was posed, a number of pages shown to the user (e.g., ten pages, twenty pages, etc.) as the result set 112, and the page of the result set 112 that was clicked by the user. Clicks may be combined into sessions and may be used to deduce the sequence of pages clicked by a user for a given query. The click log 150 may thus be used to deduce human judgments as to the relevance of particular pages. Although only one click log 150 is shown, any number of click logs may be used with respect to the techniques and aspects described herein.

The click log 150 may be interpreted and used to generate training data that may be used by the search engine 140. Higher quality training data provides better ranked search results. The pages clicked as well as the pages skipped by a user may be used to assess the relevance of a page to a query 111. Additionally, labels for training data may be generated based on data from the click log 150. The labels may improve search engine relevance ranking.

It is noted that each page that is presented in the result set 112 may have an associated document. The relevance of a page may correspond to the relevance of the page's associated document. Documents associated with pages that are usually clicked may be considered more relevant than documents associated with pages that are usually skipped.

Aggregating clicks of multiple users provides a better relevance determination than a single human judgment. A user generally has some knowledge of the query and consequently multiple users that click on a result bring diversity of opinion. For a single human judge, it is possible that the judge does not have knowledge of the query. Additionally, clicks are largely independent of each other. Each user's clicks are not determined by the clicks of others. In particular, most users issue a query and click on results that are of interest to them. Some slight dependencies exist, e.g., friends could recommend links to each other. However, in large part, clicks are independent.

Because click data from multiple users is considered, specialization and a draw on local knowledge may be obtained, as opposed to a human judge who may or may not be knowledgeable about the query and may have no knowledge of the result of a query. In addition to more “judges” (the users), click logs also provide judgments for many more queries. The techniques described herein may be applied to head queries (queries that are asked often) and tail queries (queries that are not asked often). The quality of each rating improves because users who pose a query out of their own interest are more likely to be able to assess the relevance of pages presented as the results of the query.

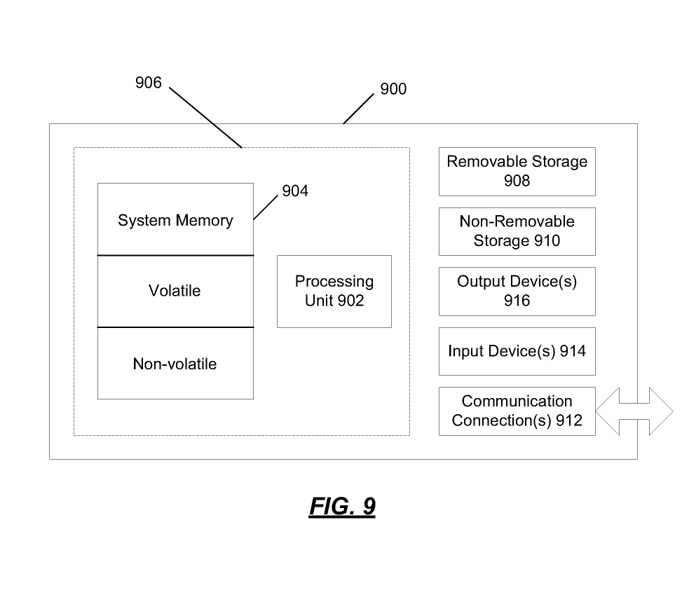

The ranking engine 142 may comprise a log data analyzer 145 and a training data generator 147. The log data analyzer 145 may receive click log data 152 from the click log 150, e.g., via a data source access engine 143. The log data analyzer 145 may analyze the click log data 152 and provide results of the analysis to the training data generator 147. The training data generator 147 may use tools, applications, and aggregators, for example, to determine the relevance or label of a particular page based on the results of the analysis, and may apply the relevance or label to the page, as described further herein. The ranking engine 142 may comprise a computing device which may comprise the log data analyzer 145, the training data generator 147, and the data source access engine 143, and may be used in the performance of the techniques and operations described herein. An example computing device is described with respect to FIG. 9.

It is noted that there is no cost to a user clicking on a page in the result set 112 and consequently there may be many spurious clicks. These clicks may be addressed by making decisions based only on a large number of users. Statistical measures such as the Chernoff bound show that the computed fraction of the population that prefers one page to another for a given query quickly converges to the true fraction, provided that there are sufficiently many users.

It is also noted that it is not known how far a user may read down a page and consequently it cannot be assumed that every skipped page (i.e., page in the result set that is not clicked) is not relevant. Eye-tracking studies indicate that users consider the pages in the result set around the page where they click. Thus, it may be assumed that skipped pages near where a user clicked were actually considered by the user and not clicked.

It has been found that a user is more likely to click on higher ranked pages independent of whether the page is actually relevant to the query. This is known as position bias. Search engines that are unstable, i.e., show results ranked in a different order each time a query is posed, are particularly effective in canceling out the effects of position bias.

In a result set, small pieces of the document associated with the page are presented to the user. These small pieces are known as snippets. It is noted that a good snippet (appearing to be highly relevant) of a document that is shown to the user could artificially cause a bad (e.g., irrelevant) page to be clicked more and similarly a bad snippet (appearing to be irrelevant) could cause a highly relevant page to be clicked less. It is contemplated that the quality of the snippet may be bundled with the quality of the document.

One technique of gaming a search engine based on clicks is to artificially boost the relevance of a page by clicking on it. Programs that automatically click on search results can be designed to create fraudulent clicks. For the techniques described herein, it may be assumed that bot traffic has been removed and that results are computed once per unique client computer.

The following notation may be useful for describing aspects and implementations. For a given query Q and pages A and B, let AB denote the number of times both pages A and B are clicked, ĀB denote the number of times page A is not clicked and page B is clicked, A B̅ denote the number of times page A is clicked and page B is not, and Ā B̅ denote the number of times both pages A and B are skipped (i.e., not clicked).

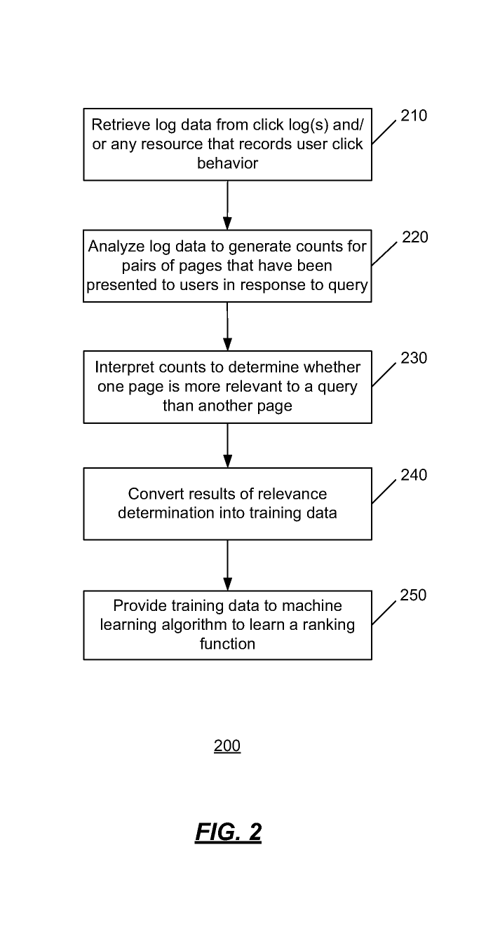

FIG. 2 is an operational flow of an implementation of a method 200 of generating training data from click logs. At 210, log data may be retrieved from one or more click logs and/or any resource that records user click behavior such as toolbar logs.

The log data may be analyzed at 220 to generate counts for pairs of pages that have been presented to users in response to a query. These counts may be referred to as pairwise information. In an implementation, it is assumed that users read from the top page to the bottom page of a result set and that the users consider pages around the page that they actually click. A click on a page in position i of a result set may imply that the pages in positions 1 through i+1 were most likely viewed by the user. Thus, for every pair of pages up to position i+1, the user's actions may be recorded. For instance, suppose that a user clicks on the pages provided in positions 2 and 4 of a result set. It may be assumed that the pages in positions 1 through 5 were read (i.e., considered) by the user (with only the pages in positions 2 and 4 being clicked on) and that the pages in positions 6 through 10 were not considered by the user. Accordingly, counts for the

$$( \begin{matrix}5 \\ 2\end{matrix} )$$

pairs 1̅2, 1̅ 3̅, 1̅4, 1̅ 5̅,2 3̅,24,2 5̅, 3̅4, 3̅ 5̅,4 5̅ may be incremented, and the pages in positions 6 through 10 may be excluded from any potential count increase. Although position i+1 is used in the above description, any number of pages following the position of the clicked page (e.g., i+2, i+3, etc.) may be considered to be read and may be included in the counts.

In another implementation, it may be assumed that users consider pages in a clustered fashion around where they click with increasing probability in the proximity of the click. Thus, for a cluster of radius three, a click on a page in position i of a search result implies that positions i−3, i−2, and i−1 are read (i.e., considered) with increasing likelihood and positions i+1, i+2, and i+3 are read with decreasing likelihood. Pairwise information about a session may thus be recorded appropriately. For example, if a user clicks only on the page in position 2 and the cluster radius is two, then the following pairs may be added to the total increment counts: 1̅2, 1̅ 3̅, 1̅ 4̅,2 3̅,2 4̅, 3̅ 4̅. In another implementation, instead of adding one for each page pair, a weighted number proportional to how likely the page pair is may be added. In this example, 1̅2 may have a higher weight than 2 4̅, since it is more likely that the page at position 1 was considered by the user than the page at position 4.

In an implementation, data for every query may be collected. Alternatively, data from a subset of queries may be collected by sampling according to the frequency of the query.

At 230, the counts that had been generated may be interpreted to determine whether one page is more relevant to a query than another page. A page A may be considered to be more relevant than a page B for a query Q if the count of A B̅ exceeds the count of ĀB by a predetermined margin, such as three percent, five percent, etc., although any margin may be used. The margin may be represented as γ. In an implementation, page A may be considered to be more relevant than page B if

A B̅/(AB+ĀB+A B̅)>ĀB/(AB+ĀB+A B̅)+γ. (Equation 1)

Alternatively, the margin may be multiplicative instead of additive. In an implementation, the denominators in Equation 1 may be based on whether one page or the other page in the pair was clicked (i.e., ĀB+A B̅) or whether both pages were considered (i.e., AB+ĀB+A B̅+Ā B̅).

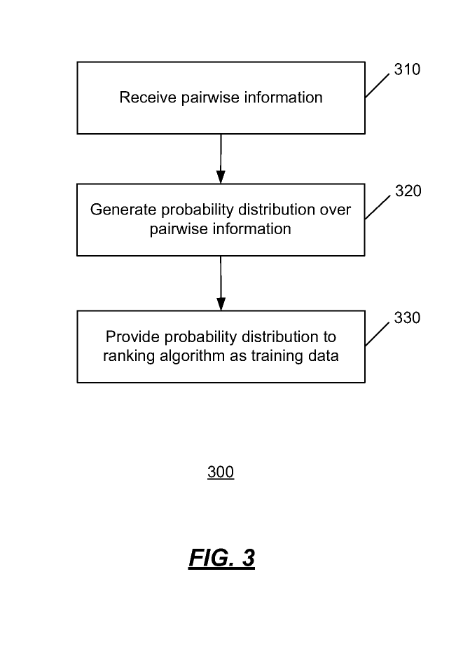

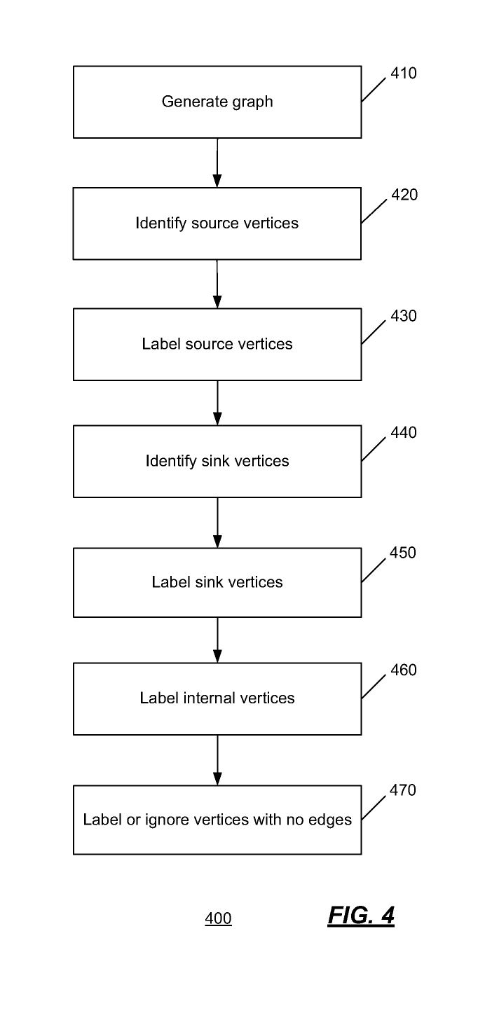

At 240, the results of the relevance determination may be converted into training data. In an implementation, described with respect to FIG. 3, the training data may comprise the relevance of a page with respect to another page for a given query. The training data may take the form that one page is more relevant than another page for the given query. In other implementations, such as those described with respect to FIGS. 4-8, a page may be ranked or labeled with respect to the strength of its match or relevance for a query. The ranking may be numerical (e.g., on a numerical scale such as 1 to 5, 0 to 10, etc.) where each number pertains to a different level of relevance or textual (e.g., “perfect”, “excellent”, “good”, “fair”, “bad”, etc.).

At operation 250, the training data may be provided as input to a machine learning algorithm that may be used to learn a ranking function (i.e., a ranking algorithm). The ranking function may be used to provide results to queries. Any machine learning algorithm may be used, such as RankBoost, LambdaRank, or RankNet.

FIG. 3 is an operational flow of another implementation of a method 300 of generating training data from click logs. At 310, the pairwise information for pairs of pages for a query may be received. At 320, a probability distribution over the pairwise information may be generated. The probability distribution corresponds to how strongly one page should be ranked over another page for a given query. Any distribution may be used, such as a uniform distribution (i.e., each pair is equal in weight and consideration) or a weight can be assigned based on the extent to which a page A is preferred over a page B, i.e., how much the count of A B̅ exceeds the count of ĀB. At 330, the probability distribution may be provided to a ranking algorithm as training data.

FIG. 4 is an operational flow of another implementation of a method 400 of generating training data from click logs. Labels may be created based on a graph which may be generated by the pairwise information, e.g., of 220. Labels may include “perfect”, “excellent”, “good”, “fair”, and “bad”, for example, although any numerical or textual labels may be used.

More particularly, at 410, a graph may be generated based on the pairwise information. The data from the click log that may be used in the generation of the graph may include the query, the pages shown to the user as the result set, and the page the user selected by clicking on it. For a given query, if page A is more relevant than page B, then an edge may be created from page A to page B. As noted above, a page A may be considered to be more relevant than a page B for a query Q, if the count of A B̅ exceeds the count of ĀB by a predetermined margin γ.

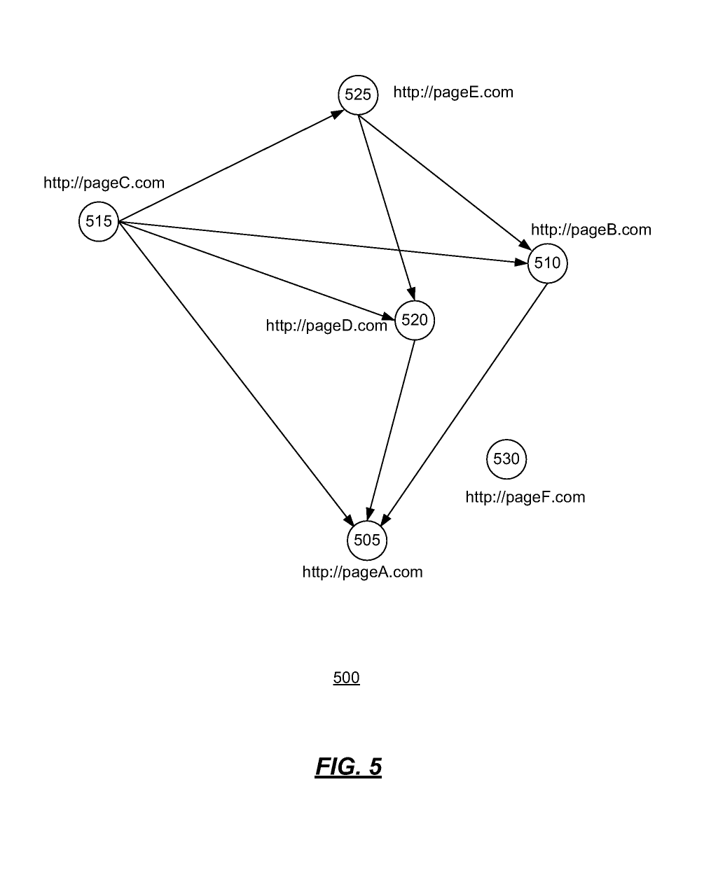

An example of a graph 500 for a query is shown in FIG. 5. Six vertices 505, 510, 515, 520, 525, 530 are shown, with each vertex corresponding to a particular page (e.g., http://pageA.com, http://pageB.com, etc.) of a result set for the query. Based on the click and skip behavior of users for the query, there is an edge from a page i to a page j if more users click on page i and skip page j versus skipping page i and clicking page j.

A vertex with a relatively high number of outgoing edges may be considered to be associated with a highly relevant page, and a vertex with a relatively high number of incoming edges may be considered to be associated with a less relevant page. In an implementation, source vertices (those with mostly or only outgoing edges) in the graph may be identified at 420. Because source vertices have many outgoing edges, their associated pages may be considered better pages than others, and may be labeled accordingly (e.g., “perfect”, “excellent”, “10”, etc.) at 430. In the graph 500, vertex 515 may be considered to be a source vertex and thus highly relevant because of the large number of outgoing edges and no incoming edges.

Sink vertices (those vertices with mostly or only incoming edges) may be identified at 440. Pages associated with sink vertices may be considered less relevant than other pages, and may be labeled accordingly (e.g., “bad”, “irrelevant”, “0”, etc.) at 450. In the graph 500, vertex 505 may be considered to be a sink vertex and thus irrelevant because of the large number of incoming edges and no outgoing edges.

At 460, pages corresponding to the vertices in the graph 500 that are neither sources nor sinks (i.e., internal vertices), but do have incoming edges and outgoing edges (e.g., vertices 510, 520, 525) may be labeled accordingly, with a label providing an indication of relevance between the label for a page corresponding to a source vertex and the label for a page corresponding to a sink vertex. Examples of such labels may be “good”, “intermediate”, “medium relevant”, “5”, etc., although any label may be used.

At 470 the vertices that contain no edges at all (e.g., vertex 530) may be labeled accordingly (e.g., rated “fair”, “3”, etc.) or may be ignored altogether. A page corresponding to such a vertex may be deemed not to have been considered by a user in response to the given query.

It is contemplated that finer granularity of labels may be generated by clustering internal vertices into multiple categories. Additionally, pages that have similar content may be merged, such that their corresponding vertices are merged. This may provide a more accurate indication of a page's relevance to a query.

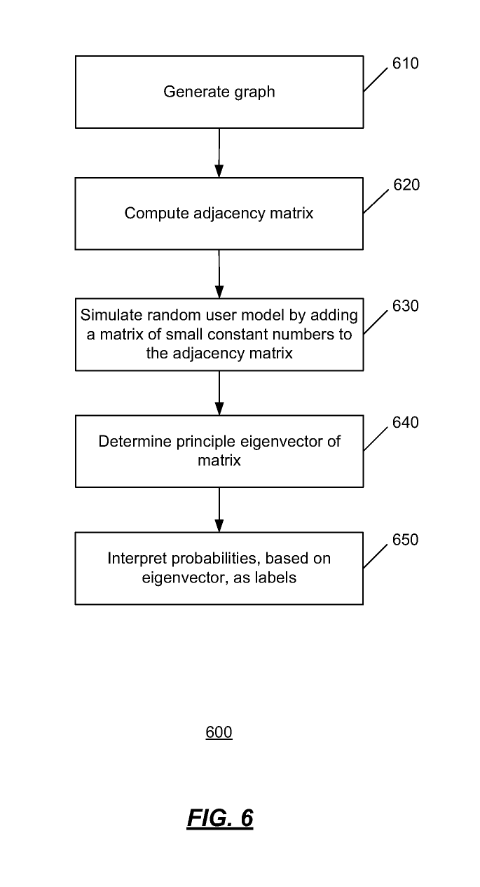

FIG. 6 is an operational flow of another implementation of a method 600 of generating training data from click logs. In an implementation, the probability that a random walk on the graph ends at a vertex may be used to deduce a label. At 610, a graph may be generated, similar to the graph of 410. At 620, the adjacency matrix of the graph may be computed, i.e., 1/deg(i) if there is an edge from j to i, and 0 otherwise. In another implementation, at 620, a weighted edge may be computed from i to j, i.e., wᵢⱼ/Σⱼ wᵢⱼ where wᵢⱼ is the number of users that clicked i and skipped j. At 630, to simulate a random user model, a matrix of constant small numbers, e.g. 0.10, 0.15, etc. for all i,j, may be added to the adjacency matrix. At 640, the principle eigenvector of the matrix may be determined.

Probabilities may be based on the eigenvector and may be interpreted as labels at 650. Higher probabilities may be interpreted as pages that are more relevant to a query than lower probabilities. Any technique may be used for converting the probabilities into labels. In an implementation, to assign X labels for example, the probability interval [0,1] may be evenly broken into X segments of length 1/X, where X may be any number. In another implementation, the probabilities may be X-clustered by any one of a number of clustering techniques. Each cluster may then be treated as a class corresponding to a label.

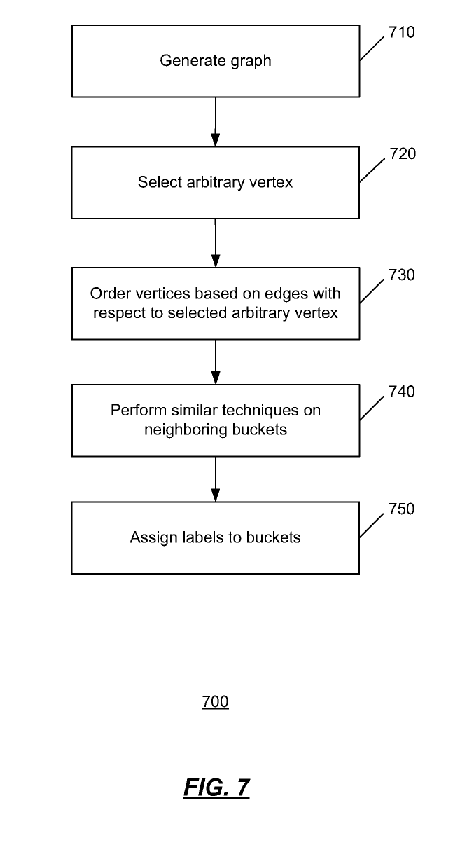

FIG. 7 is an operational flow of another implementation of a method 700 of generating training data from click logs. Here, pairwise preferences may be turned into bucket orders, to arrange the vertices of a graph on a line with a minimum weight of back edges.

At 710, a graph may be generated, similar to the graph of 410. At 720, an arbitrary vertex v of the graph may be selected. At 730, ordering may be performed such that if there is an outgoing edge (v,w) then vertex w may be put to the right of vertex v and if there is an incoming edge (u,v) then vertex u may be put to the left of vertex v. If a vertex x is incomparable to vertex v then vertex x is left in a bucket with vertex v.

Similar techniques may be performed on the right and left neighboring buckets (but not the incomparable bucket) at 740. This produces a collection of ordered buckets. The buckets may be assigned labels at 750 based on their relative relevance.

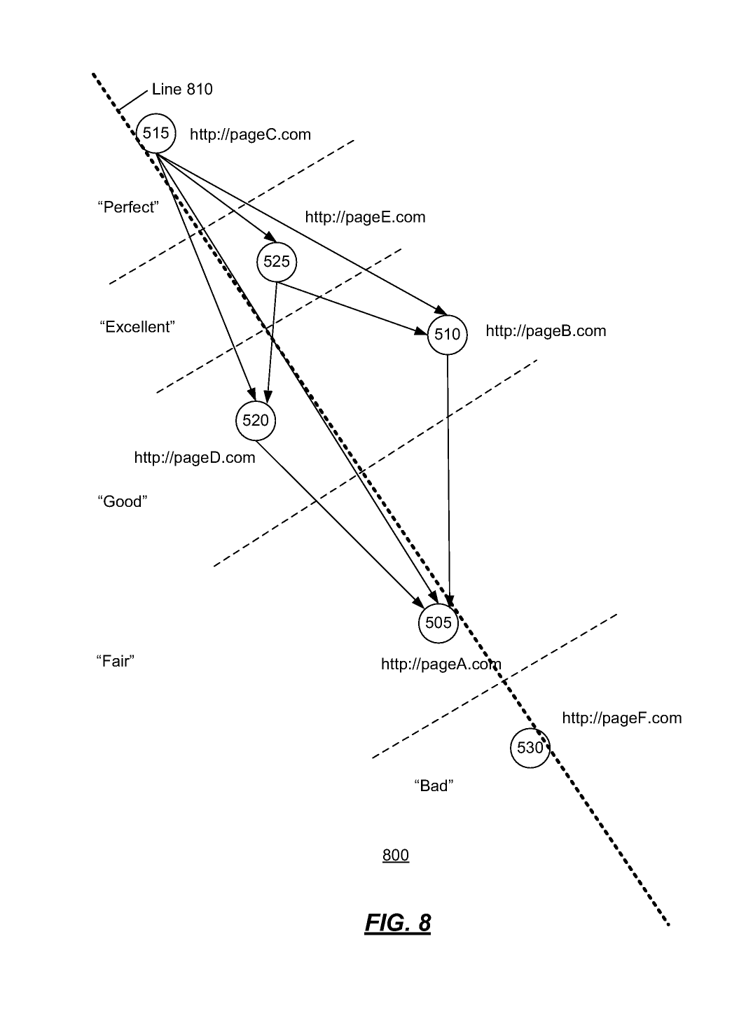

FIG. 8 is a diagram of another graph 800 that may be used in generating training data from click logs. As with the graph 500, the graph 800 comprises six vertices 505, 510, 515, 520, 525, 530, with each vertex corresponding to a particular page (e.g., http://pageA.com, http://pageB.com, etc.) of a result set for the query. Edges are generated based on the click and skip behavior of users for the query as with the graph 500. The graph 800 orders the vertices in a linear fashion around a line 810, with a source vertex 515 at one end of the line 810 and a sink vertex 505 at the other end of the line 810. In an implementation, a vertex 530 having no edges will be placed at the end of the line 810 opposite the source vertex 515, since the probability a random walk terminates at vertex 530 is low.

Internal vertices 510, 520, 525 are shown on the line 810. The internal vertices having more outgoing edges than incoming edges may be placed closer to the source vertex or the more relevant end of the line 810 than the vertices having fewer outgoing edges than incoming edges. The vertices 510 and 520 are shown at approximately the same position relative to the line 810 because they have the same number of incoming edges and outgoing edges, and thus may have the same relevance.

Each vertex of the graph 800 may be placed or distributed into one of a plurality of buckets, with each bucket corresponding to a relative relevance or label. For example, the source vertices may be in one bucket corresponding to a high relevance, and the sink vertices may be in another bucket corresponding to a low relevance. Internal vertices may be placed in intermediate relevance buckets. Vertices with no edges may be ignored or placed into irrelevant or other buckets. As shown in the graph 800, the vertices may be labeled e.g., as “perfect”, “excellent”, “good”, “fair”, “bad”, depending on their position along the line 810 (i.e., into which bucket they were placed).

A dynamic programming algorithm may be used to split the line 810 of vertices of the graph 800 into a number of buckets. Assume that the buckets are ordered so that they represent integers on the line 810. A partitioning of these buckets into a number of pieces is performed to maximize the weight of edges crossing the split from left to right and minimize the weight of edges crossing the split from right to left. If many users express a preference that page A is more relevant than page B and if page A<page B on the line 810, then pages A and B may be placed in different buckets. On the other hand, if users prefer page B to page A and page A<page B on the line 810, then a split may not be placed between pages A and B.

More particularly, let OPT([i,j],k) denote the optimum partitioning of the interval [i,j] into k buckets. OPT([i,j],k) may be described recursively as follows

$$OPT ( [ i , j ] , k ) = {min}_{i < l < j} OPT ( [ i , l ] , k - 1 ) + \vert \{ ( u , v ) \text{∷} i \leq u \leq l , ( l + 1 ) \leq v \leq j \} \vert - \vert \{ ( v , u ) \text{:} i \leq u \leq l , ( l + 1 ) \leq v \leq j \} \vert$$

Such a recursive characterization gives rise to a polynomial-time algorithm.

FIG. 9 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as RAM), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of computer readable media. Computer readable media can be any available media that can be accessed by device 900 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communications connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of generating training data for a search engine, comprising:
retrieving log data pertaining to user click behavior;
analyzing the log data to determine a relevance of each of a plurality of pages for a query; and
converting the relevance of the pages into training data.

2. The method of claim 1, wherein retrieving log data comprises retrieving the log data from a click log.

3. The method of claim 1, wherein analyzing the log data comprises generating a plurality of counts for the pages, and wherein the relevance is based on the counts.

4. The method of claim 3, wherein generating the plurality of counts for the pages comprises generating a count for each pair of pages that is presented for the query.

5. The method of claim 4, further comprising incrementing the count for each pair of pages that has been considered by a user based on the log data.

6. The method of claim 5, further comprising determining which of the pages have been considered based on a proximity of each of the pages to a page that has been clicked.

7. The method of claim 4, wherein the count for each pair of pages is associated with pairwise information, and wherein converting the relevance of the pages into training data comprises generating a probability distribution over the pairwise information, the training data being based on the probability distribution.

8. The method of claim 1, further comprising providing one of a plurality of labels to each of the pages based on the relevance of each of the pages.

9. The method of claim 1, further comprising generating a graph based on the log data.

10. The method of claim 9, wherein the graph comprises a plurality of vertices, each vertex associated with one of the pages, and a plurality of edges between pairs of the vertices, each edge corresponding to the relevance between the vertices in the pair.

11. The method of claim 10, further comprising identifying a source vertex, a sink vertex, and an internal vertex, and providing a different relevance label to the pages corresponding to the source vertex, the sink vertex, and the internal vertex.

12. A method of generating training data for a search engine, comprising:
retrieving log data from a click log;
generating a graph based on the log data, the graph comprising a plurality of vertices, each vertex associated with at least one of a plurality of pages for a query, and a plurality of edges between pairs of the vertices, each edge corresponding to a relevance between the vertices in the pair; and
determining a relative relevance of each of the pages based on the graph.

13. The method of claim 12, further comprising providing a label to each of the pages based on the relative relevance.

14. The method of claim 13, further comprising providing each label to the search engine as training data.

15. The method of claim 12, wherein determining the relative relevance comprises:
computing an adjacency matrix of the graph; and
simulating a random user model of the graph.

16. The method of claim 12, wherein determining the relative relevance comprises:
arranging the vertices of the graph in a linear fashion along a line;
distributing the vertices among a plurality of buckets, each bucket associated with a portion of the line and a relevance label; and
providing a label to each page based on the relevance label of the bucket containing the vertex associated with the page.

17. A computer-readable medium comprising computer-readable instructions for generating training data, said computer-readable instructions comprising instructions that:
retrieve log data from a click log, the log data comprising a query, a result set, and a page of the result set that was clicked by a user;
analyze the log data to determine a relevance of each of the pages of the result set; and
provide each of the pages with a ranking based on the relevance of each of the pages for the query.

18. The computer-readable medium of claim 17, wherein the ranking comprises a label.

19. The computer-readable medium of claim 17, wherein the ranking is numerical or textual.

20. The computer-readable medium of claim 17, further comprising instructions that provide the ranking of each of the pages to a search engine as training data.
